(19) United States
(12) Patent Application Publication
(10) Pub. No.: US 2012/0191740 A1
(43) Pub. Date: Jul. 26, 2012

(54) Document Comparison

(75) Inventor: Martin G. Moehrle, Bremen (DE)

(73) Assignee: UNIVERSITY BREMEN, Bremen (DE)

(21) Appl. No.: 12/665,654

(22) PCT Filed: Sep. 9, 2009
(86) PCT No.: PCT/EP2009/061713

§ 371 Date: Feb. 19, 2010

(51) Int. Cl. G06F 17/30

(52) U.S. Cl. 707/758; 707/E17.008; 707/E17.045

(57) ABSTRACT

A method of comparing first and second documents, the method comprising determining criteria of the comparison, selecting comparison means based on the criteria from a plurality of comparison means, and performing the comparison of the first and second documents by using the selected comparison means. Also disclosed is a method of comparing first and second documents, the first document including or associated with one or more first concepts, the second document including or associated with one or more second concepts, the method comprising displaying a diagram having first and second axes, the first axis corresponding to positions of the first concepts within the first document, the second axis corresponding to positions of the second concepts within the second document, the method further comprising displaying or highlighting one or more points on the diagram, each point at a position on the first axis corresponding to a first one of the concepts in the first document and on the second axis corresponding to a second one of the concepts in the second document, whereby the first concept is identical or similar to the second concept.

### CROSS-REFERENCE TO RELATED APPLICATIONS

This application is a U.S. national stage application of PCT application PCT/EP2009/061713, filed Sep. 9, 2009.

### BACKGROUND OF THE INVENTION

1. Field of the Invention

Embodiments of the invention relate to document comparison, for example for comparing the text content of documents.

2. Description of the Related Art

Document comparison using electronic means is useful, particularly when there are a large number of documents to compare especially when the documents have a similar structure and are segmentable within this structure. Electronic document comparison may use one or more data processing systems to compare text from the documents, the text also being in or being obtainable in electronic form.

For example, an individual may wish to compare two or more patent documents (that is, granted patents, patent applications, provisional applications, utility model applications and the like). There exists an enormous number of published patent documents, making the task of manually comparing the documents, or selecting documents for comparison, complicated. Electronic methods of comparing patent documents or selecting documents for comparison may therefore be useful.

### SUMMARY OF THE INVENTION

Aspects of embodiments of the invention are set out in the claims.

### BRIEF DESCRIPTION OF THE DRAWINGS

Embodiments of the invention will now be described by way of example only with reference to the following figures, in which:

FIG. 1 shows an example of determining variables in a complete linkage method according to embodiments of the invention;

FIG. 2 shows an example of determining variables in a complete linkage method according to embodiments of the invention;

FIG. 3 shows an example of determining variables in a complete linkage method according to embodiments of the invention;

FIG. 4 shows an example of determining variables in a reduced linkage method according to embodiments of the invention;

FIG. 5 shows an example of determining variables in a wedding linkage method according to embodiments of the invention;

FIG. 6 shows an example of determining variables in an integer linkage method according to embodiments of the invention;

FIG. 7 shows an example of determining variables in a bounded integer linkage method according to embodiments of the invention;

FIG. 8 shows an example of a method for comparing documents according to embodiments of the invention;

FIG. 9 shows an example of a diagram for comparing documents according to embodiments of the invention; and

FIG. 10 shows an example of a data processing system suitable for use with embodiments of the invention.

### DETAILED DESCRIPTION OF EMBODIMENTS OF THE INVENTION

Embodiments of the invention compare two or more documents based on the concepts that are found within the documents. Concepts may comprise, for example, general notions, ideas or subjects found or referred to in the documents. The concepts may then be used to determine one or more numerical values reflecting the similarity of the documents. Additionally or alternatively, the concepts and their locations within the documents may be used to produce a diagram of concepts that are common to multiple documents, indicating in which part of the documents there are accumulations of similar concepts, thus leading to an in-depth analysis of document relationships.

According to first embodiments of the invention, criteria of a document comparison are determined, and comparison means for comparing the documents are selected based on the criteria. The comparison means may then be used to compare the documents, for example to provide one or more numerical values reflecting the similarity or some of its facets of two or more documents.

A numerical value reflecting the similarity of two documents may use variables based on the concepts within the two documents. A document may include or be associated with one or more concepts. There may be multiple concepts that are identical or similar (for example, use alternative words for the same or similar meaning). Concepts within a document may be predefined or may be extracted from the document. There are various ways of extracting concepts from a document and an example is provided below. Concepts may be determined by extraction from a document or by accessing the predefined concepts, or by other means. Where a concept is referred to as occurring multiple times, having duplicates or being identical to another concept, this should be understood to mean that the multiple concepts are identical or similar to each other.

In a first method of extracting concepts from a document, free morphemes or root forms of words are considered. For example, where a document contains any of the words “machine”, “machines” or “machinery”, these may all be considered to be the single word “machine”. Thus, each word in the document is replaced by its free morpheme. Next, certain words are disregarded. For example, certain words may be likely to appear in many if not most or all of the documents under consideration. In patent documents, for example, the words “figure”, “show”, “embodiment”, “claim” and others may be expected to be in a large proportion of the documents under consideration. These words may be disregarded. The remaining words can be considered to be a list of the concepts in the document.

Once concepts have been determined, variables may be calculated based on the concepts. For example, according to certain embodiments of the invention, up to five variables may be defined. cᵢ is the number of concepts in a first document (document i). cⱼ is the number of concepts in a second document (document j). Where there are multiple identical or similar concepts in a single document, these are counted each time they appear, and so the variables cᵢ and cⱼ may be higher than the number of unique concepts in the respective documents. The variable cᵢ₍ⱼ₎ is the number of concepts in document i that have identical or similar equivalents in document j. cⱼ₍ᵢ₎ is the number of concepts in document j that have identical or similar equivalents in document i. cᵢⱼ is the number of concepts that can be found in both documents. cᵢⱼ may differ from cᵢ₍ⱼ₎ and cⱼ₍ᵢ₎, which may depend on a method selected for measuring these variables.

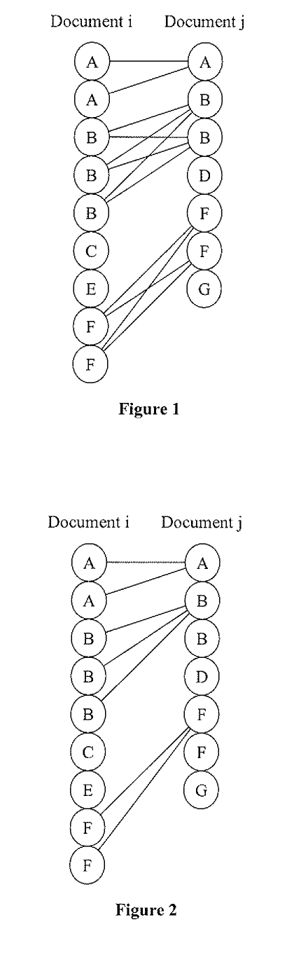

A method is selected for measuring the variables from a number of methods. The selected method may give different results for the variables cᵢ₍ⱼ₎, cⱼ₍ᵢ₎ and cᵢⱼ than other methods. The methods differ in the way they consider multiple occurrences of identical or similar concepts in a single document. One method, “complete linkage”, is shown in FIG. 1, which shows an example of concepts in or associated with two example documents. In the complete linkage method, each concept is treated as if it is unique and is counted separately from other concepts, even other identical or similar concepts. As shown in FIG. 1, document i includes five concepts, A, B, C, E and F. In document i, concept A appears twice, concept B appears three times, concept C appears once, concept E appears once and concept F appears twice. In document j, concept A appears once, concept B appears twice, concept D appears once, concept F appears twice and concept G appears once.

The variables cᵢ and cⱼ are counts of the number of concepts in document i and document j respectively, and are 9 and 7 respectively. To calculate the variable cᵢⱼ, the total number of common concepts is determined. Therefore, for complete linkage, multiple concepts in one document that have identical concepts in the other document are considered multiple times. This is illustrated by lines drawn between identical or similar concepts in FIG. 1. Thus, the two occurrences of concept A in document i and the single occurrence in document j contribute 2 to the variable cᵢⱼ, and the three occurrences of concept B in document i and the two occurrences in document j contribute 6 to cᵢⱼ, because each occurrence of concept B in document i is considered against each occurrence in document j. Thus, the final value for cᵢⱼ is 12.

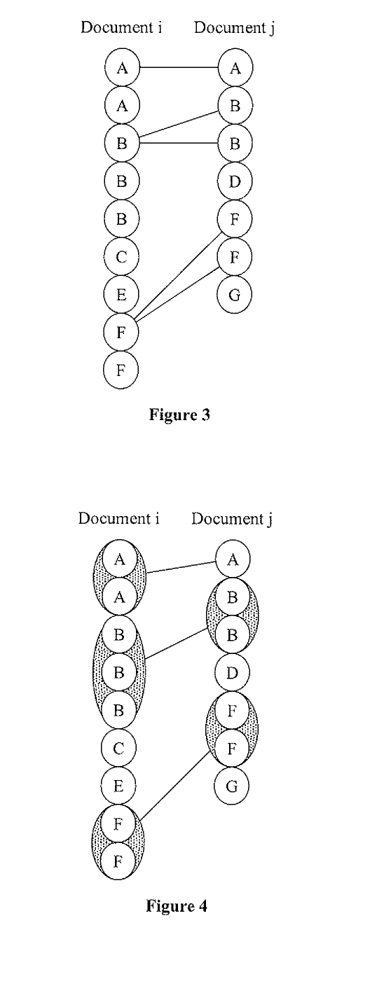

FIG. 2 illustrates an example of calculation of the variable cᵢ₍ⱼ₎, which indicates the number of concepts in document i that can also be found in document j. Again, multiple occurrences of a concept in document i are considered multiple times, although multiple occurrences of a concept in document j do not affect the value of cᵢ₍ⱼ₎. The value for cᵢ₍ⱼ₎ in the example shown is 7. Similarly, FIG. 3 shows an example of calculation of the variable cⱼ₍ᵢ₎, which is 5 in the example shown.

A second method for measuring the variables is shown in FIG. 4. This method, called “reduced linkage”, considers multiple occurrences of identical or similar concepts in a document as just one occurrence. Therefore, as shown in FIG. 4, the variable cᵢⱼ is determined to be 3. Similarly, the variables cᵢ₍ⱼ₎ and cⱼ₍ᵢ₎ are also measured to be 3.

A third method for measuring the variables, called “wedding linkage”, is shown in FIG. 5. In this method, for each concept in one document, a match is searched for in the other document. Where a match is found, this contributes to the variable cᵢⱼ for example, and the matched concepts in both documents can no longer be used. Therefore, for multiple occurrences of a concept to be counted multiple times, there must be multiple occurrences in both documents. For example, as shown in FIG. 5, there are multiple occurrences of the concept A in document i, but only one in document j, so concept A contributes only once to cᵢⱼ. On the other hand, there are three occurrences of concept B in document i and two in document j, so the concept B contributes twice to cᵢⱼ. In the example shown, using the wedding linkage method provides cᵢⱼ=5, cᵢ₍ⱼ₎=5 and cⱼ₍ᵢ₎=5.

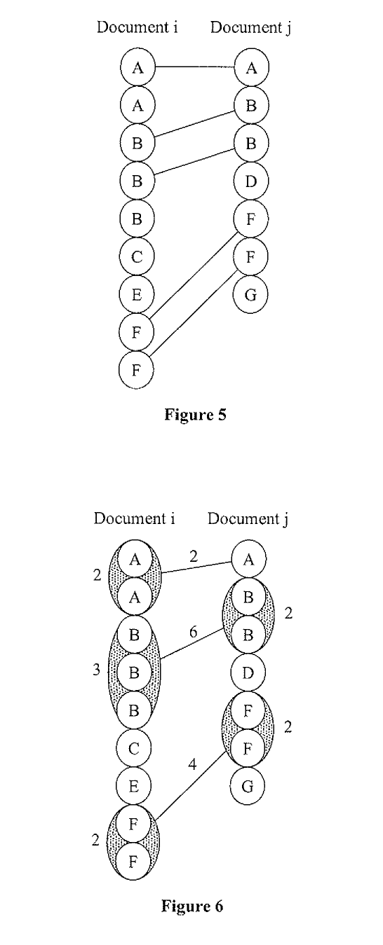

A fourth method, “integer linkage”, is shown in FIG. 6. In this method, multiple concepts are treated as a single concept for calculating the variables as in reduced linkage. However, the number of multiple occurrences is used to provide a weighting to the contribution to the variables of the reduced concepts. In the example shown in FIG. 6, the weighting given is the number of occurrences of a concept in document i multiplied by the number of occurrences of this concept in document j. For example, the contribution to cᵢⱼ by the concept B is 3×2=6. This weighting gives results for the variables as cᵢⱼ=cᵢ₍ⱼ₎=cⱼ₍ᵢ₎=12. However, in alternative embodiments other weighting methods can be used.

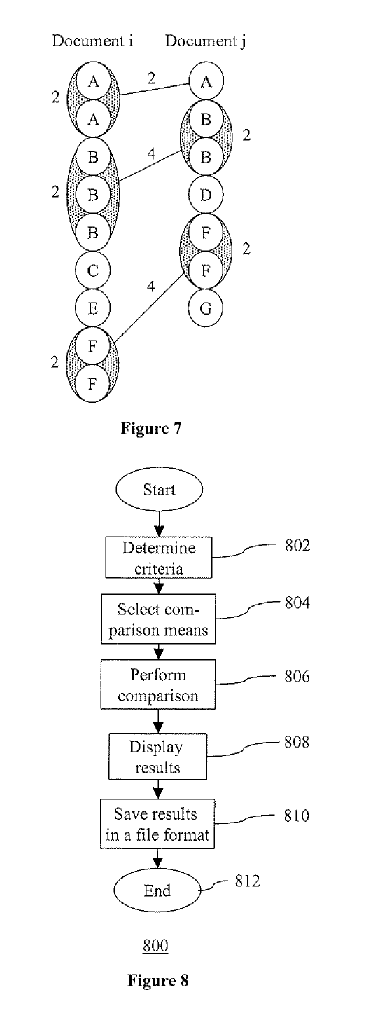

A fifth method, “bounded integer linkage”, is shown in FIG. 7. This method is similar to integer linkage as described above. However, in bounded integer linkage, the weighting given to multiple occurrences of a concept in one document is no more than a predetermined maximum number. In the example shown, this maximum is 2, so the weighting given to the three occurrences of concept B in document i does not exceed 2. In the example shown, the contribution to the variables such as cᵢⱼ by common concepts between the documents is equal to the weighting given to the number of occurrences of the concept in document i multiplied by the weighting given in document j. For example, the contribution by concept B is 2×2=4. According to this example, the variables are calculated to be cᵢⱼ=cᵢ₍ⱼ₎=cⱼ₍ᵢ₎=10, although as for the integer linkage method other ways of calculating the contribution and/or other maximum values can be used.

Once a method of calculating the variables has been chosen and the variables have been calculated, a method is chosen for determining a value that reflects the similarity between the two documents being compared. In certain embodiments of the invention, this comprises choosing one of a number of similarity coefficient formulas. Examples of similarity coefficient formulas are given below. The formulas can be split into two categories: those that give two-sided overlap coefficients, and those that give double single-sided overlap coefficients.

The two-sided overlap coefficient formulas use the variables cᵢ, cⱼ and cᵢⱼ. A number of examples of such formulas are given in table 1 below:

TABLE 1
two-sided overlap similarity coefficient formulas

| Similarity coefficient | Definition |
|---|---|
| Jaccard | $\frac{{c}_{ij}}{{c}_{i} + {c}_{j} - {c}_{ij}}$ |
| Sorensen | $\frac{2 {c}_{ij}}{{c}_{i} + {c}_{j}}$ |
| Sokal & Sneath 2 | $\frac{{c}_{ij}}{2 ( {c}_{i} + {c}_{j} ) - 3 {c}_{ij}}$ |
| Kulczynski 1 | $\frac{{c}_{ij}}{{c}_{i} + {c}_{j} - 2 {c}_{ij}}$ |
| Kulczynski 2 | $\frac{\frac{{c}_{ij}}{{c}_{i}} + \frac{{c}_{ij}}{{c}_{j}}}{2}$ |
| Cosine | $\sqrt{\frac{{c}_{ij}}{{c}_{i}} \cdot \frac{{c}_{ij}}{{c}_{j}}} = \frac{{c}_{ij}}{\sqrt{{c}_{i} \cdot {c}_{j}}}$ |
| Inclusion | $min ( \frac{{c}_{ij}}{{c}_{i}} , \frac{{c}_{ij}}{{c}_{j}} )$ |

Double single-sided (DSS) overlap coefficient formulas use the variables cI, cj, ci(j) and cj(i), and a number of examples are given in table 2 below:

TABLE 2
double single-sided overlap similarity coefficient formulas

| Similarity coefficient | Definition |
|---|---|
| DSS-Jaccard | $\frac{{c}_{i ( j )} + {c}_{j ( i )}}{{c}_{i} + {c}_{j}}$ |
| DSS-Inclusion | $max ( \frac{{c}_{i ( j )}}{{c}_{i}} , \frac{{c}_{j ( i )}}{{c}_{j}} )$ |
| DSS-Inclusion (extreme variant) | $\frac{max ( {c}_{i ( j )} , {c}_{j ( i )} )}{min ( {c}_{i} , {c}_{j} )}$ |
| DSS-Gamma-Inclusion | $- 1 + [ {( \frac{{c}_{i ( j )}}{{c}_{i}} )}^{γ} + {( \frac{{c}_{j ( i )}}{{c}_{j}} )}^{1 - γ} ] ,$ 0 ≦ γ ≦ 1 |

The DSS-Gamma-Inclusion formula includes a weighting variable γ. This variable can be used to balance between two simple one-sided coefficients. For example, to balance the formula equally between the two one-sided coefficients, γ is chosen to be 0.5.

Of the two-sided overlap similarity coefficient formulas listed above, the Jaccard, Cosine and Inclusion coefficients will be considered further. However, in alternative embodiments, other formulas for the two-sided and DSS overlap similarity coefficients may be used that may or may not be those listed above.

Table 3 below gives results for selected ones of the two-sided overlap similarity coefficient formulas using various methods for determining the variable cᵢⱼ as identified above. The results provide values reflecting the similarity of the two documents being compared.

TABLE 3
two-sided overlap similarity coefficient results

| Similarity | Complete | Reduced | Wedding | Bounded |
|---|---|---|---|---|
| coefficient | linkage | linkage | linkage | integer linkage |
| Jaccard | 3 | 0.43 | 0.45 | 1.67 |
| Inclusion | 1.7 | 1 | 0.71 | 1.43 |
| Cosine | 1.52 | 1 | 0.63 | 1.26 |

Table 4 below gives results for the double single-sided (DSS) overlap similarity coefficient formulas. For DSS-Gamma-Inclusion, γ=0.5.

TABLE 4
DSS overlap similarity coefficient results

| Similarity | Complete | Reduced |
|---|---|---|
| coefficient | linkage | linkage |
| DSS-Jaccard | 0.75 | 0.6 |
| DSS-Inclusion | 0.78 | 0.6 |
| DSS-Gamma- | 0.73 | 0.55 |
| Inclusion | | |

In certain embodiments of the invention, document comparison means comprise or include the formula and the method for determining the variables used by the formula. The document comparison means are selected based on one or more criteria of the comparison. For example, the criteria of the comparison may include a purpose of the comparison of the documents, an importance of considering duplicate concepts in the documents, a distribution of duplicate concepts and a size distribution of documents. These examples are explained in more detail below.

One of the criteria used in the selection of the document comparison means may comprise a purpose of the document comparison. For example, where one or both of the documents is a patent document, the purpose may comprise a prior art analysis, infringement analysis or patent document similarity mapping. For prior art or infringement analysis, a document of interest may be compared with a plurality of other patent documents. It may be undesirable to miss any patent document that is potentially similar to the document of interest. Therefore, for example, a threshold of 0.2 may be set, and a document that has a similarity coefficient of greater than the threshold may be marked for manual comparison with the document of interest. In this case, selection of the inclusion or DSS-inclusion similarity coefficient formula may be desirable, as the values from these formulas tend to be greater than for other formulas as shown above. Thus, more documents are above the threshold and more documents are marked for manual comparison, reducing the risk that an important document is not marked for manual comparison.

For patent mapping, a m*m matrix of similarity coefficients may be obtained where m is the number of documents being compared. As a result of the large number of coefficients, it may be appropriate to use a more conservative similarity coefficient formula, such as Jaccard or DS S-Jaccard.

The criteria may also include an importance of considering duplicate concepts in the documents. In some cases, for example, there may be rare or unusual concepts in one of the documents being compared, and so selection of document comparison means that puts greater emphasis on multiple occurrences of identical or similar concepts may be desired. Thus, use of the complete linkage method for variable measurement may be appropriate, and/or use of a two-sided overlap similarity coefficient formula may also be appropriate. This may result in a higher similarity coefficient between those documents that include multiple occurrences of the rate or unusual concepts.

The criteria may also include distribution of duplicate concepts. That is, consideration of the number of identical or similar concepts in each document in the plurality of documents that are involved in the comparison exercise. For example, an average may be taken for each document of the number of occurrences of each concept that occurs multiple times in that document, and then an average of all of the averages is determined. Alternatively, for example, the ratio of the number of unique concepts to the total number of concepts (including duplicate concepts) throughout the documents may be determined. The resulting value may be used in the selection of the document comparison means. For example, a higher value may suggest more multiple occurrences of identical or similar concepts. Therefore, selection of document comparison means that puts less emphasis on multiple occurrences may be appropriate, such as selection of a DSS formula and/or variable measurement other than complete linkage.

Another of the criteria that may be used in selection of the document comparison means is a size distribution of the documents being compared. The “size” of the documents being considered is the number of concepts within the documents and may or may not reflect the physical size of or amount of text in the documents. The distribution of the documents may be reflected by the variance in the size of the documents. A low variance may mean that use of the Jaccard or DSS-Jaccard similarity coefficient formula may be appropriate, whereas a high variance may mean that use of the inclusion or DSS-inclusion formula may be appropriate. In case of a high variance the documents have different sizes, thus making it more likely that a large document will be compared with a small one. In this case the inclusion and DSS-inclusion formula may be preferable because they indicate if a small document is included in a large one, whereas this is less clear from the other formulas.

Thus, as indicated above, in embodiments of the invention, the comparison means for comparing two or more documents may be chosen based on criteria of the comparison. The comparison may be performed on properties of the documents that comprise, for example, numbers of concepts that are found in or are associated with the documents.

FIG. 8 shows an example of a method 800 for comparing two or more documents. First, in step 802, the criteria of the comparison are determined. Examples of such criteria are given above. Next, in step 804, comparison means are selected based on the criteria. Then, in step 806, the comparison of the documents is performed using the selected comparison means. In step 808, the results are being displayed in form of a table. In step 810, the results are saved in a specific file format, such as csv. The method 800 then ends at step 812.

In alternative embodiments of the invention, a diagram may be displayed that may allow a user to visualize the similarity between two documents being compared. In some embodiments, the diagram is a two-dimensional diagram having a first axis and a second axis. Each axis corresponds to one of the documents being compared and positions along an axis indicates the positions in the corresponding document of concepts within or associated with that document.

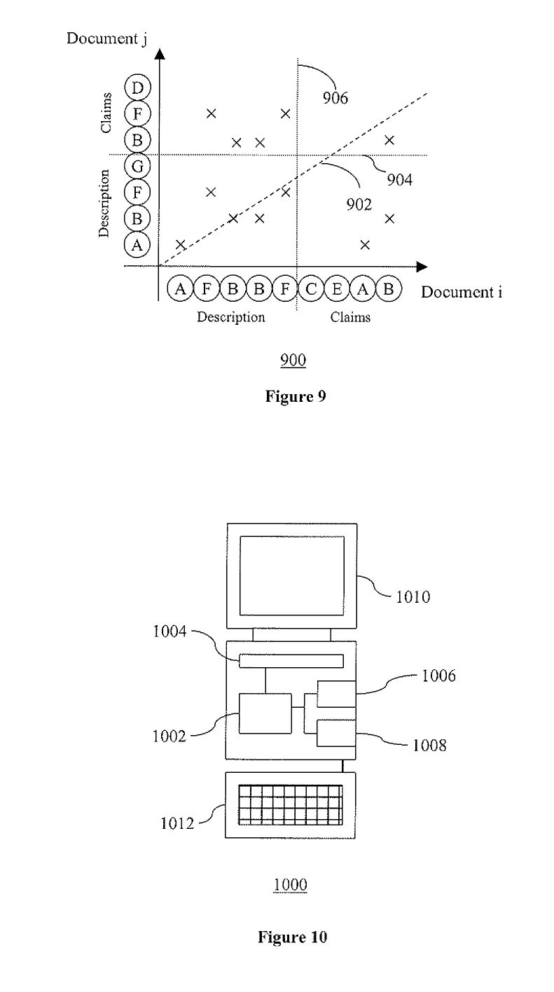

FIG. 9 shows an example of such a diagram 900. The horizontal axis corresponds to document i, whereas the vertical axis corresponds to document j. The documents i and j include the same concepts as the documents i and j shown in FIGS. 1 to 7. The concepts within each document are shown on the corresponding axes for illustration purposes, although these may not be displayed on the diagram 900. The sequence in that the concepts are ordered on both axis corresponds to the occurance of the concepts in the documents.

Concepts that are common to both documents are highlighted on the diagram 900 at the appropriate positions on the horizontal and vertical axes with a “x”, although other ways of highlighting these points are possible. Thus, in the example shown, there are 12 such points highlighted, equal to the variable cᵢⱼ in the complete linkage method as described above. In alternative embodiments, the principles from other methods such as integer linkage and wedding linkage may be applied to the highlighting of points on the diagram 900, possibly leading to fewer such points.

The diagram 900 is particularly useful when comparing patent documents. These documents normally have a predetermined structure and, for example, may contain one or more of the following sections in a predetermined order: background, summary, detailed description, claims, and other sections. Therefore, where two documents are similar such that the corresponding sections include or are associated with some identical or similar concepts, the highlighted points on the diagram 900 may approximate a linear pattern. The highlighted points on the example diagram 900 could be in a generally linear arrangement as indicated by the dotted line 902, which may or may not appear on the diagram. Here, the term “linear” should be interpreted to mean that for a highlighted point, the distance from one of the axes tends to increase along with the distance from the other axis, although not necessarily in a linear manner.

Alternatively, there may occur other structures: As shown in diagram 900 all axes may be subdivided according to the document structure, meaning in several parts. Dotted line 904 divides the Y-axis, dotted line 906 divides the X-axis. In a patent document, for instance, such parts are the description and the claims. With the method described in this patent it is now possible to analyse the similarities between the parts within a document and between parts of different documents. As shown in diagram 900, a lot of the concepts both of the description and the claim part of document i is similar to a lot of the concepts of the description part of document j, but only a few to the claim part of document j. This may indicate that document j is a following document to document i. Other implications may also be obtained by this kind of analysis.

In the above description, a document is referred to as a single entity. However, a document may instead comprise multiple documents combined, or a portion of one or more documents. Where two documents are compared, this may be a comparison of two portions from the same document.

Concepts are determined in the above description for the documents being compared. However, in embodiments of the invention these concepts could be determined for a document every time the document is to be used in a comparison, or the concepts may be predetermined and retrieved when required.

FIG. 10 shows an example of a data processing system 1000 that is suitable for use when implementing embodiments of the invention. The data processing system 1000 includes a central processing unit (CPU) 1002 and a main memory 1004. The system 1000 may also include a permanent storage device 1006, such as a hard disk, and/or a communications device 1008 such as a network interface controller (NIC). The system 1000 may also include a display device 1010 and/or an input device 1012 such as a mouse and/or keyboard.

The method according to the present invention may be embodied by software and/or hardwired processing means.

The documents to which the present invention is applicable may be input as linguistic data (texts), for example ASCII data in the .csv format. Inputting the data in the .csv format is particularly advantageous if the processed documents are patents which may include a different number of concepts in each patent, thus avoiding empty fields in a relational database, for example.

The output of the comparison results in accordance with the present invention may be represented by data in a database, particularly a relational database, for example in the .mdb or .assdb format. This enables a speedy processing of the obtained comparison results.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Embodiments of the invention are not restricted to the details of any foregoing embodiments. Embodiments of the invention extend to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments that fall within the scope of the claims.

### REFERENCES

The following documents are incorporated herein by reference for all purposes:
[1] J. C. GOWER, P. LEGENDRE, Metric and Euclidean properties of dissimilarity coefficients, Journal of Classification, 3 (1986) 5-48
[2] K. BACKHAUS, Multivariate Analysemethoden. Eine anwendungsorientierte Einführung, Springer, Berlin et al., 2006
[3] F. BROSIUS, SPSS 14, Redline, Heidelberg, 2006.
[4] J. QIN, Semantic Similarities between a Keyword Database and a Controlled Vocabulary Database: An Investigation in the Antibotic Resistance Literature, Journal of the American Society for Information Science, 51 (2000), 166-180
[5] R. R. BRAAM, H. F. MOED, A. F. J. VAN RAAN, Mapping of Science: Critical elaboration and new approaches, a case study in agricultural biochemistry, L. EGGHE, R. ROUSSEAU, Infometrics 87/88, Elseiver Science Publishers, Amerstdam et al., 1988
[6] P. H. A. SNEATH, R. R. SOKAL, Numerical Taxonomy, W. H. Freeman and Company, San Francisco, 1973
[7] A. DRESSLER, Patente in technologieorientierten Mergers & Acquisitions, Deutscher Universitäts-Verlag, Wiesbaden, 2006
[8] A. RIP, P. COURTAL, CO-word maps of biotechnology: An example of cognitive scientometrics, Scientometrics, 6 (1984) 381-400
[9] J. BUHWAN, D. LEE, H. CHO, J. LEE, A novel method for measuring semantic similarity for XML schema matching, Expert Systems with Applications, 34 (2008), 1651-1658
[10] V. BATAGELJ, M. BREN, Comparing Resemblance Measures, Journal of Classification, 12 (1995), 73-90
[11] A. J. TRIPPE, Patinformatics: Tasks to tools, World Patent Information, 25 (2003), 211-221
[12] J. J. SEPKOSKI, Quantified Coefficients of Association and Measurement of Similarity, Mathematical Geology, 6 (1974), 135-152
[13] L. YANHONG, T, T. RUNHUA, A Text-Mining-bases Patent Analysis in Product Innovative Process, in: N. Léon-Rvira, Trends in Computer Aided Innovation, New York, Springer-Verlag, 2007, 89-96
[14] ABOU-ASSALEH, TONY; CERCONE, NICK; KESELJ, VLADO; SWEIDAN, RAY: N-gram-based Detection of New Malicious Code, in: Proceedings of the 28th Annual International Computer Software and Applications Conference (COMPSAC'04), 2004
[15] MOENS, MARIE-FRANCINE: Information Extraction: Algorithms and Prospects in a Retrieval Context, Springer 2006
[16] KARTHIK, M. N.; DAVIS, MOSHE: Search Using N-gram Technique Based Statistical Analysis for Knowledge Extraction in Case Based Reasoning Systems CoRR cs.AI/0407009, 2004
[17] TSOURIKOV, VALERY M.; BATCHILO, LEONID S.; SOVPEL, IGOR V.: U.S. Pat. No. 6,167,370. Document semantic analysis/selection with knowledge creativity capability utilizing subject-action-object (SAO) structures, 2000.

1. A method of comparing first and second documents, the method comprising:
determining criteria of the comparison;
selecting comparison means based on the criteria from a plurality of comparison means; and
performing the comparison of the first and second documents by using the selected comparison means.

2. A method as claimed in claim 1, wherein using the selected comparison means comprises applying the selected comparison means to first properties of the first document and second properties of the second document.

3. A method as claimed in claim 2, wherein the comparison means includes property determining means for determining the first and second properties, and the method comprises determining the first and second properties using the property determining means.

4. A method as claimed in claim 3, wherein the properties include properties of concepts in the first and/or second documents.

5. A method as claimed in claim 4, wherein the property determining means comprises a plurality of rules each for determining a number of unique and/or repeated concepts in the first and/or second document and/or a number of concepts common to the first and second documents, and wherein selecting the comparison means comprises selecting one of the plurality of rules.

6. A method as claimed in claim 4, comprising determining the concepts in the first and/or second documents.

7. A method as claimed in claim 2, wherein selecting the comparison means comprises selecting at least one of a plurality of document comparison formulae each of which provide a measure of similarity of the first and second documents from the first and second properties.

8. A method as claimed in claim 7, wherein the selected at least one document comparison formula comprises at least one of a Jaccard, double-single-sided (DSS)-Jaccard, cosine, inclusion, DSS-inclusion and DSS-gamma-inclusion document comparison formulae.

9. A method as claimed in claim 1, wherein the criteria of the comparison comprise one or more of a purpose of the comparison, an importance of considering duplicate concepts in each of the first and second documents, a distribution of the duplicate concepts and a size distribution of a plurality of documents that include the first and second documents.

10. A method of comparing first and second documents, the first document including or associated with one or more first concepts, the second document including or associated with one or more second concepts, the method comprising displaying a diagram having first and second axes, the first axis corresponding to positions of the first concepts within the first document, the second axis corresponding to positions of the second concepts within the second document, the method further comprising displaying or highlighting one or more points on the diagram, each point at a position on the first axis corresponding to a first one of the concepts in the first document and on the second axis corresponding to a second one of the concepts in the second document, whereby the first concept is identical or similar to the second concept.

11. A method as claimed in claim 10, further comprising: subdividing the axes according to a common structure of the first and second documents, the common structure representative of at least two separable portions of each of the documents, thereby displaying or highlighting occurrences of concepts in one portion of the first documents identical or similar to concepts in another portion of the second document.

12. An apparatus arranged to implement the method as claimed in claim 1.

13. An apparatus as claimed in claim 12, wherein the apparatus comprises a data processing system.

14. An apparatus arranged to implement the method as claimed in claim 10.

15. An apparatus as claimed in claim 14, wherein the apparatus comprises a data processing system.

16. A computer program comprising code for implementing a method as claimed in claim 1.

17. Computer readable storage storing a computer program as claimed in claim 16.

18. A computer program comprising code for implementing a method as claimed in claim 10.

19. Computer readable storage storing a computer program as claimed in claim 18.
